(19) United States
(12) Patent Application Publication
(10) Pub. No.: US 2020/0324884 A1
(43) Pub. Date: Oct. 15, 2020

(54) ENGAGEMENT AND DISENGAGEMENT OF TAIL ROTOR

(71) Applicant: Bell Helicopter Textron Inc., Fort Worth, TX (US)

(72) Inventors: Matthew Michael Wilcox, Fort Worth, TX (US); Aaron Alexander Acee, Flower Mound, TX (US)

(73) Assignee: Bell Helicopter Textron Inc., Fort Worth, TX (US)

(21) Appl. No.: 16/382,052

(22) Filed: Apr. 11, 2019

(51) Int. Cl. B64C 27/12; B64D 35/02; B64D 35/04; B60L 7/18; F16D 3/06

(52) U.S. Cl. CPC B64C 27/12; B64D 35/02; B64D 35/04; F16H 7/02; F16D 3/06; B60L 2200/10; B60L 7/18

(57) ABSTRACT

An exemplary rotorcraft includes a propulsion system including a prime mover and a drive shaft coupled to the prime mover, the drive shaft including a coupling separating the drive shaft into an input shaft and an output shaft, the coupling operable between an engaged position rotationally coupling the input shaft and the output shaft and a disengaged position rotationally disengaging the output shaft from the input shaft, a main rotor coupled to the prime mover, a secondary rotor attached to the output shaft, and a motor coupled to the output shaft.

### TECHNICAL FIELD

This disclosure relates in general to the field of rotorcraft, and more particularly, to disengagement of an anti-torque rotor.

### BACKGROUND

This section provides background information to facilitate a better understanding of the various aspects of the disclosure. It should be understood that the statements in this section of this document are to be read in this light, and not as admissions of prior art.

A rotorcraft may include one or more rotor systems. One example of a rotorcraft rotor system is a main rotor system. A main rotor system may generate aerodynamic lift to support the weight of the rotorcraft in flight and thrust to counteract aerodynamic drag and move the rotorcraft in forward flight. Another example of a rotorcraft rotor system is a tail rotor system. A tail rotor system may generate thrust in the same direction as the main rotor system's rotation to counter the torque effect created by the main rotor system.

### SUMMARY

An exemplary rotorcraft includes a propulsion system including a prime mover and a drive shaft coupled to the prime mover, the drive shaft including a coupling separating the drive shaft into an input shaft and an output shaft, the coupling operable between an engaged position rotationally coupling the input shaft and the output shaft and a disengaged position rotationally disengaging the output shaft from the input shaft, a main rotor coupled to the prime mover, a secondary rotor attached to the output shaft, and a motor coupled to the output shaft.

An exemplary method of operating a rotorcraft having a propulsion system including a prime mover and a drive shaft coupled to the prime mover, the drive shaft including a coupling separating the drive shaft into an input shaft and an output shaft, a main rotor coupled to the prime mover, and a secondary rotor coupled to the output shaft, the coupling operable between an engaged position rotationally coupling the input shaft and the output shaft and a disengaged position rotationally disengaging the output shaft from the input shaft, includes actuating the coupling to a disengaged position disengaging the secondary rotor from the prime mover and spooling up the main rotor with the prime mover while the secondary rotor is disengaged from the prime mover. An exemplary embodiment also includes driving, when the coupling in the disengaged position, the output shaft with a motor to a speed synchronous with the input shaft driven by the prime mover and actuating the coupling to the engaged position when the input shaft speed and the output shaft speed are synchronous.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates an exemplary rotorcraft implementing a system to engage the tail rotor to the main rotor propulsion system and to disengage the tail rotor from the main rotor propulsion system.

FIG. 2 illustrates an exemplary rotor system according to one or more aspects of the disclosure.

FIG. 3 illustrates an exemplary rotor engagement system.

FIG. 4 illustrates another exemplary rotor engagement system.

FIG. 5 illustrates another exemplary rotor engagement system.

FIG. 6 illustrates an exemplary method according to one or more aspects of the disclosure.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

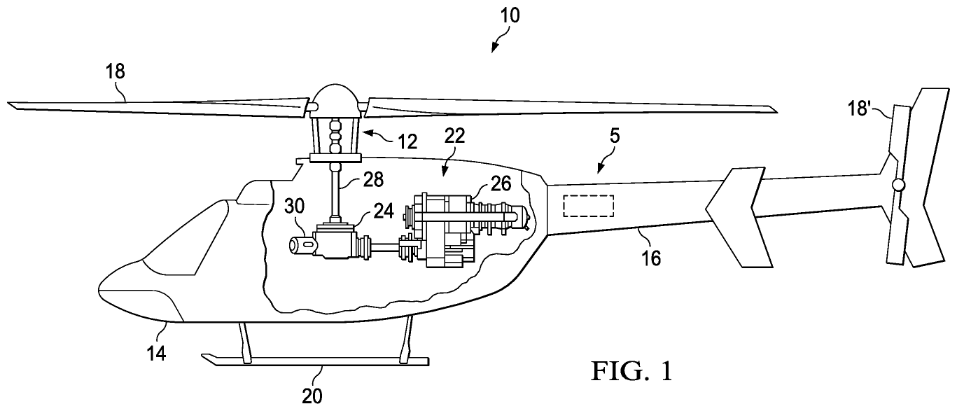

FIG. 1 illustrates an exemplary rotorcraft 10 incorporating a rotor engagement system 5 according to an embodiment of the disclosure. Rotorcraft 10 includes a rotor system 12, a fuselage 14, and an empennage 16. Rotor system 12 may include rotor 18 (e.g., blades). Rotor system 12 may include a control system for selectively controlling the pitch of each rotor blades in order to selectively control direction, thrust, and lift of rotorcraft 10. Fuselage 14 represents the body of rotorcraft 10 and may be coupled to rotor system 12 such that rotor system 12 and rotor 18 may move fuselage 14 through the air. Landing gear 20 supports rotorcraft 10 when rotorcraft 10 is landing and/or when rotorcraft 10 is at rest on the ground. Empennage 16 represents the tail section of the aircraft and features components of a rotor system 12 and secondary or anti-torque rotor 18′. Rotor 18′ may provide thrust in the same direction as the rotation of rotor 18 so as to counter the torque effect created by rotor system 12 and rotor 18. Teachings of certain embodiments relating to rotor systems described herein may apply to rotor system 12 and/or other rotor systems, such as other helicopter rotor and tiltrotor systems. It should also be appreciated that teachings from rotorcraft 10 may apply to aircraft other than rotorcraft, such as airplanes and unmanned aircraft, to name a few examples. Teachings of certain embodiments recognize that secondary rotor 18′ may represent one example of a rotor or anti-torque rotor; other examples include, but are not limited to, tail propellers, ducted tail rotors, and ducted fans mounted inside and/or outside the aircraft.

Rotorcraft 10 includes a propulsion system 22 to drive rotor system 12. Propulsion system 22 includes a prime mover 26 mechanically coupled to main rotor 18. Prime mover 26 may be an electric motor or an engine. In the illustrated exemplary rotorcraft 10, prime mover 26 is an engine and propulsion system 22 includes a transmission 24 mechanically coupled to engine 26. Main rotor 18 is mechanically connected to transmission 24 through mast 28. A secondary rotor, tail rotor blade 18′ in the illustrated exemplary rotorcraft, is mechanically connected to prime mover 26 through engagement system 5. Device 30 may be a generator or hydraulic pump connected to propulsion system 22 to provide electricity or hydraulic pressure to various components.

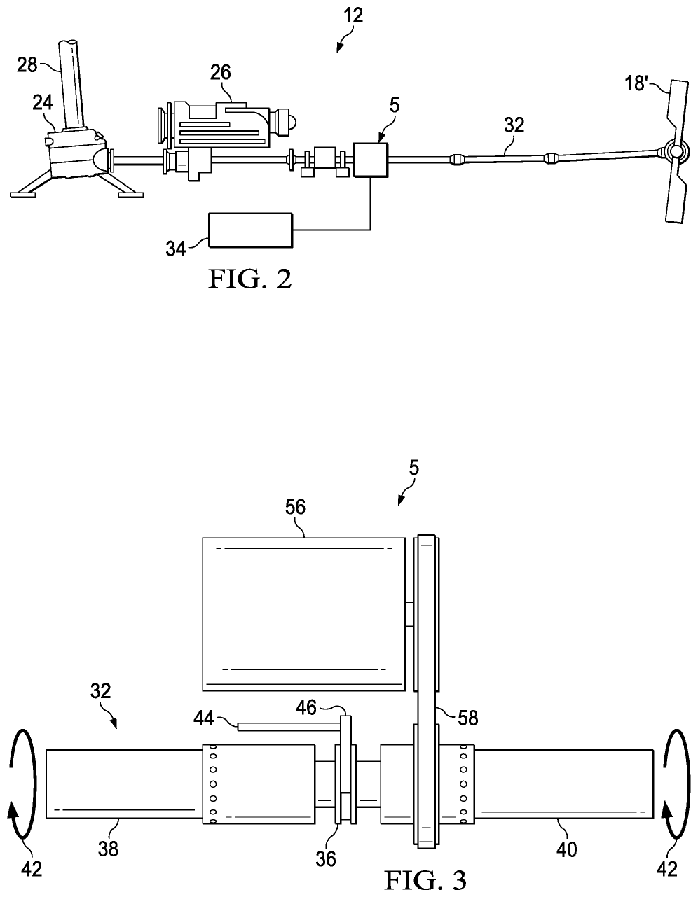

FIG. 2 illustrates an exemplary rotor system 12. Engine 26 is mechanically connected to tail rotor 18′ through a drive shaft 32 coupled with engagement system 5. Engagement system 5 may include an alternative power source 34. Alternative power source 34 may include device 30, driven by engine 26, or a separate power source such as a battery, capacitor, or flywheel.

Tail rotor 18′ may pose certain safety issues. For example, when rotorcraft 10 is operating but still on the ground, tail rotor 18′ may spin within feet of the ground. In this example, tail rotor 18′ may pose a safety risk to ground personnel walking near rotorcraft 10. Although ideally, ground personnel should not walk near rotorcraft 10 while rotorcraft 10 is operating on the ground, sometimes such circumstances are practically unavoidable. For example, it may be necessary for medical personnel to approach rotorcraft 10 while rotorcraft 10 is still operating in order to unload an injured person from rotorcraft 10. Accordingly, teachings of certain embodiments recognize the capability to disengage the tail rotor such that rotor system 12 no longer spins tail rotor 18′.

Although disengaging tail rotor 18′ may resolve some safety issues, however, additional issues may arise if tail rotor 18′ is disengaged at the wrong time. In particular, rotorcraft 10 may not fly properly if tail rotor 18′ is disengaged when rotorcraft 10 is off the ground. Such may be the case, for example, if a pilot attempts to takeoff from the ground while tail rotor 18′ is still disengaged.

Accordingly, teachings of certain embodiments recognize the capability to prevent disengagement of the tail rotor system as well as provide for reengagement of the tail rotor system based on operating conditions of the aircraft. In some embodiments, these operating conditions may be indicative of whether the aircraft is on the ground or in the air. Teachings of certain embodiments recognize the capability to prevent disengagement of the tail rotor system if the operating conditions do not satisfy predetermined criteria that indicate that the aircraft is on the ground at the time of disengagement.

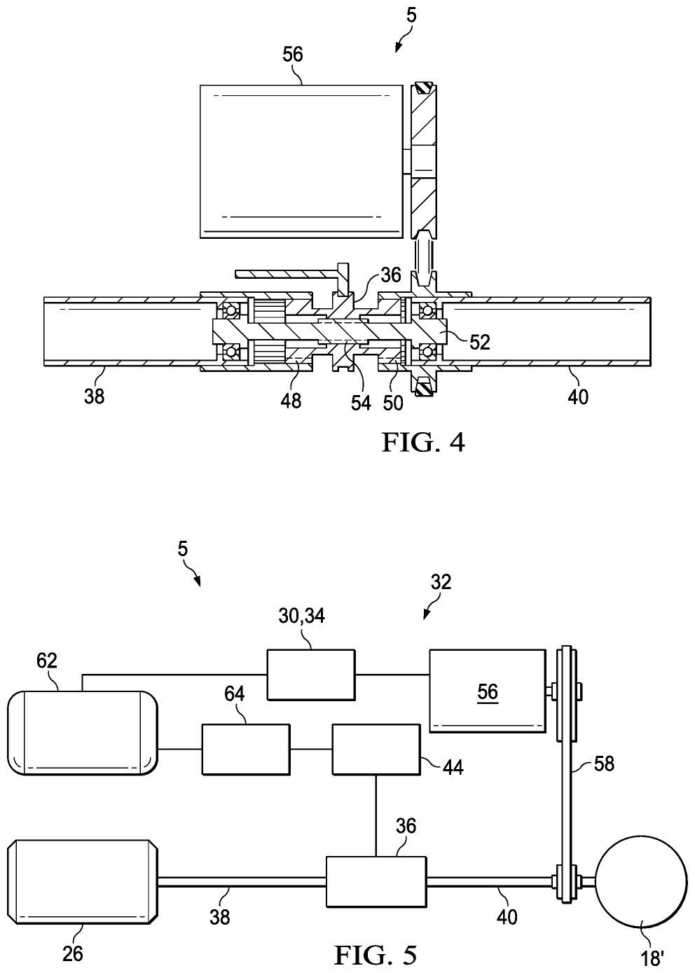

FIGS. 3 and 4 illustrate an exemplary embodiment of a rotor engagement system 5. Rotor engagement system 5 includes a sliding coupling 36 within drive shaft 32 separating drive shaft 32 into an input shaft 38 and a rotor shaft 40. In an embodiment, sliding coupling 36 is a spline or gear-tooth coupling. When sliding coupling 36 is in an engaged position, torque 42 is transferred from input shaft 38 through sliding coupling 36 to rotor shaft 40. When sliding coupling 36 is in the disengaged position, torque 42 is not transferred from input shaft 38 to rotor shaft 40. In FIGS. 3 and 4, sliding coupling 36 is actuated via a push/pull tube 44 through a shifting fork 46. Push/pull tube 44 may be operated manually from the fuselage or via an actuator. With reference to FIG. 4, coupling 36 includes an input spline 48, output or rotor spline 50, alignment shaft 52, and alignment shaft spline 54.

Rotor engagement system 5 includes a motor 56 rotationally connected to the output or rotor shaft 40. Motor 56 may be an electric or hydraulic motor. Motor 56 is used, when coupling 36 is disengaged, to bring the rotational speed of rotor shaft 40 up to the speed of input shaft 38 to allow sliding coupling 36 to be actuated to the engaged positioned. Because the rotational velocities of the input shaft 38 and rotor shaft 40 are not identical, the initial engagement of sliding coupling 36 may use a friction system that will allow some relative movement prior to full engagement. This may be accomplished via a synchronizer.

When the tail rotor blades are at flat-pitch, a traditional tail rotor generates relatively low drag at idle speed and is lower in inertia than the main rotor drive system. This allows a relatively small and lightweight motor 56 to be utilized without the need for any additional wear items like friction clutches. For example, motor 56 may be a 10 horsepower or less motor. In accordance with an embodiment, motor 56 is a 3 horsepower motor.

In the exemplary embodiment, motor 56 is coupled to rotor shaft 40 with a belt 58. Motor 56 may be connected to rotor shaft 40 through a belt drive due to the lower power of the system and the fact that motor 56 is only operated on the ground. Motor 56 may include a clutch 60 to disengage from belt 58 when a threshold rotational speed is exceeded, for example, flight speed or a speed between idle and flight speed. In an embodiment, belt 58 is connected to motor 56 through a clutch 60, e.g. centrifugal clutch. When coupling 36 is engaged, power is cut to motor 56 the rotational speed of the motor driven shaft slows disengaging the centrifugal clutch.

FIG. 5 illustrates another exemplary embodiment of a rotor engagement system 5. Tail rotor 18′ is mechanically coupled to engine 26 through a drive shaft 32. Drive shaft 32 includes a coupling 36 separating drive shaft 32 into an input shaft 38 and an output or rotor shaft 40. Coupling 36 is operable via actuator device 44 between an engaged positioned rotationally connecting input shaft 38 to rotor shaft 40 and a disengaged position rotationally disengaging input shaft 38 from rotor shaft 40. A controller 62 is operationally connected to actuator device 44. Controller 62 may be or include a manual controller, for example, a stick, pedal, switch. Controller 62 may be or include a computer processor. A lock-out system or device 64 may be operationally connected to actuator device 44 to prevent accidental disengagement of rotor 18′ for example during flight. Motor 56 is operationally connected to rotor 18′ and rotor shaft 40 for example by belt 58. Motor 56 may be a hydraulic or electric motor. Motor 56 may be connected to a main rotor propulsion system driven power supply device 30, e.g., an electric generator or a hydraulic pump. Motor 56 may be operationally connected to a battery 34 to supply electric power to motor 56.

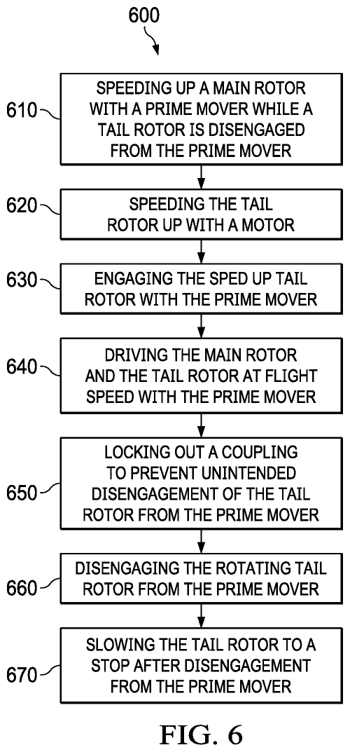

An exemplary method 600 of operating a rotorcraft 10 is now described with reference to FIGS. 1-6. At block 610, during rotorcraft 10 startup, coupling 36 is disengaged allowing engine 26 and main rotor blades 18 to spool up while tail rotor 18′ is disengaged, allowing safety for ground personnel. At block 620, when rotorcraft 10 is ready to takeoff and ground personnel are clear of rotorcraft 10, motor 56 spools tail rotor 18′ up to idle speed. At block 630, when motor 56 has spooled rotor shaft 40 up to idle speed and the speed of input shaft 38 and rotor shaft 40 are synchronous, coupling 36 is operated to the engaged position rotationally connecting input shaft 38 to rotor shaft 40. At block 640, rotor 18 and tail rotor 18′ spools up to flight speed, via engine 26, and rotorcraft 10 performs a mission. At block 650, operation of coupling 36 is locked-out to prevent accidental disengagement to tail rotor 18′ from engine 26. The lock-out system 64 may be associated with the speed of tail rotor 18′, for example when tail rotor 18′ speed exceeds the idle speed the system may be locked out. In an embodiment, coupling 36 may have centrifugally activated pins or levers that lock the coupling when the speed of rotor shaft 40 exceeds a threshold level. In another embodiment, activator tube 44 is manually operated and lock-out system 64 may include a mechanical lock-out, e.g., pin or detent, located in the fuselage. In another embodiment, lock-out system 64 may include an electric solenoid. At block 660, coupling 36 is operated to the disengaged position thereby disengaging tail rotor 18′ from main rotor 18 and engine 26. At block 670, rotation of tail rotor 18′ slows to a stop after a period of time. Once tail rotor 18′ is disengaged, aerodynamic torque and friction slows its rotation. In some embodiments, motor 56 may be used as a generator, e.g. regenerative braking, with the benefit of reducing the period of time required to stop rotation of tail rotor 18′. Additionally, in a regenerative braking embodiment, the slowing tail rotor 18′ drives motor 56 as a generator to charge power source 34.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements.

The term “substantially,” “approximately,” and “about” is defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A rotorcraft, comprising:
a propulsion system including a prime mover and a drive shaft coupled to the prime mover, the drive shaft including a coupling separating the drive shaft into an input shaft and an output shaft, the coupling operable between an engaged position rotationally coupling the input shaft and the output shaft and a disengaged position rotationally disengaging the output shaft from the input shaft;
a main rotor coupled to the prime mover;
a secondary rotor attached to the output shaft; and
a motor coupled to the output shaft.

2. The rotorcraft of claim 1, wherein the prime mover is an engine.

3. The rotorcraft of claim 1, wherein the motor is a hydraulic motor.

4. The rotorcraft of claim 1, wherein the motor is an electric motor.

5. The rotorcraft of claim 1, wherein the coupling is not a clutch.

6. The rotorcraft of claim 1, wherein the coupling is a sliding coupling.

7. The rotorcraft of claim 1, wherein the motor is coupled to the output shaft by a belt.

8. The rotorcraft of claim 1, wherein the prime mover is an engine;
the motor is an electric motor; and
the electric motor is coupled to a generator driven by the engine.

9. The rotorcraft of claim 8, wherein the electric motor is coupled to the output shaft by a belt.

10. The rotorcraft of claim 1, wherein the prime mover is an engine;
the motor is an electric motor; and
the electric motor is coupled to a battery.

11. A method, comprising:
operating a rotorcraft comprising a propulsion system including a prime mover and a drive shaft coupled to the prime mover, the drive shaft including a coupling separating the drive shaft into an input shaft and an output shaft, a main rotor coupled to the prime mover, and a secondary rotor coupled to the output shaft, the coupling operable between an engaged position rotationally coupling the input shaft and the output shaft and a disengaged position rotationally disengaging the output shaft from the input shaft;
actuating the coupling to the disengaged position disengaging the secondary rotor from the prime mover; and
spooling up the main rotor with the prime mover while the secondary rotor is disengaged from the prime mover.

12. The method of claim 11, wherein the coupling is not a clutch.

13. The method of claim 11, wherein the coupling is a sliding spline coupling.

14. The method of claim 11, further comprising driving, when the coupling in the disengaged position, the output shaft with a motor to a speed synchronous with the input shaft driven by the prime mover; and
actuating the coupling to the engaged position when the input shaft speed and the output shaft speed are synchronous.

15. The method of claim 14, wherein the prime mover is an engine and the motor is an electric motor.

16. The method of claim 14, further comprising driving the main rotor and the secondary rotor with the prime mover at a flight speed.

17. The method of claim 16, further comprising disengaging the motor from the output shaft via a clutch when the prime mover is driving the main rotor and the secondary rotor at the flight speed.

18. The method of claim 11, further comprising driving the main rotor and the secondary rotor with the prime mover while the coupling is in the engaged position;
actuating the coupling to the disengaged position while the prime mover is driving the main rotor and the input shaft; and
braking rotation of the secondary rotor with an electric motor coupled to the output shaft.

19. The method of claim 18, further comprising an electric power source connected to the electric motor; and
charging the electric power source with the electric motor while braking the secondary rotor.

20. The method of claim 11, further comprising driving, when the coupling in the disengaged position, the output shaft with a motor to a speed synchronous with the input shaft driven by the prime mover;
actuating the coupling to the engaged position when the input shaft speed and the output shaft speed are synchronous;
driving the main rotor and the secondary rotor with the prime mover while the coupling is in the engaged position; and
actuating the coupling to the disengaged position while the prime mover is driving the main rotor and the input shaft.
